(19) United States
(12) Patent Application Publication
(10) Pub. No.: US 2026/0244229 A1
(43) Pub. Date: Aug. 20, 2026

(54) REFERENCE VOLTAGE CIRCUIT

(71) Applicant: Cypress Semiconductor Corporation, San Jose, CA (US)

(72) Inventor: Adrian Lin, Austin, TX (US)

(73) Assignee: Cypress Semiconductor Corporation, San Jose, CA (US)

(21) Appl. No.: 19/058,912

(22) Filed: Feb. 20, 2025

(51) Int. Cl. G05F 1/46; G05F 3/26

(52) U.S. Cl. CPC G05F 1/468; G05F 3/262; G05F 3/265

(57) ABSTRACT

According to one or more embodiments, a reference voltage circuit includes a current generator having a first leg configured to generate a first reference current, and a second leg configured to generate a second reference current, an amplifier connected between a supply terminal and the current generator and configured to generate a third reference current, and an output stage configured to mirror the first reference current in the first leg to generate a feedback current, generate a reference voltage at an output terminal based on the feedback current, and provide the feedback current to the second leg of the current generator, wherein the second reference current is a function of the third reference current and the feedback current.

### TECHNICAL FIELD

The present disclosure relates generally to electronic circuits, and, more particularly, to reference voltage circuits with low bias current and high accuracy.

### BACKGROUND

Reference voltage circuits are widely used in integrated circuits to provide reference voltages that are relatively constant regardless of fluctuations in supply voltage, load, time, temperature, process variation, or the like.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

According to one or more embodiments, a reference voltage circuit comprises a current generator comprising a first leg configured to generate a first reference current, and a second leg configured to generate a second reference current, an amplifier connected between a supply terminal and the current generator and configured to generate a third reference current, and an output stage configured to mirror the first reference current in the first leg to generate a feedback current, generate a reference voltage at an output terminal based on the feedback current, and provide the feedback current to the second leg of the current generator, wherein the second reference current is a function of the third reference current and the feedback current.

According to one or more embodiments, a reference voltage circuit comprises an output terminal, and a current generator comprising a first bipolar junction transistor having a first size, a resistor, a second bipolar junction transistor connected to the resistor and having a second size greater than the first size, an output stage configured to mirror current in the first bipolar junction transistor to generate a feedback current and generate a reference voltage at the output terminal, and an amplifier connected to the first bipolar junction transistor and the resistor and configured to balance current in the first bipolar junction transistor and the second bipolar junction transistor such that current in the second bipolar junction transistor includes the current in the first bipolar junction transistor and the feedback current.

According to one or more embodiments, a method for generating a reference voltage comprises generating a first reference current in a first leg of a current generator, generating a second reference current in a second leg of the current generator, generating a third reference current equal to the first reference current in an amplifier, mirroring the first reference current in the first leg to generate a feedback current, generating a reference voltage at an output terminal based on the feedback current, and providing the feedback current to the second leg of the current generator, wherein the second reference current is a function of the third reference current and the feedback current.

According to one or more embodiments, a system for generating a reference voltage comprises means for generating a first reference current in a first leg of a current generator, means for generating a second reference current in a second leg of the current generator, means for generating a third reference current equal to the first reference current in an amplifier, means for mirroring the first reference current in the first leg to generate a feedback current, means for generating a reference voltage at an output terminal based on the feedback current, and means for providing the feedback current to the second leg of the current generator, wherein the second reference current is a function of the third reference current and the feedback current.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a schematic diagram of a reference voltage circuit, according to some embodiments.

FIG. 2 is a schematic diagram of a reference voltage circuit with current feedback, according to some embodiments.

FIG. 3 is a schematic diagram of a reference voltage circuit with current feedback and current chopping, according to some embodiments.

FIG. 4 is a schematic diagram of a chopping circuit, according to some embodiments.

FIG. 5 is a flow diagram of a method for generating a reference voltage, according to some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

In this regard, directional terminology, such as “top”, “bottom”, “below”, “above”, “front”, “behind”, “back”, “leading”, “trailing”, etc., may be used with reference to the orientation of the figures being described. Because parts of embodiments can be positioned in a number of different orientations, the directional terminology is used for purposes of illustration and is in no way limiting. It is to be understood that other embodiments may be utilized and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In embodiments described herein or shown in the drawings, any direct electrical connection or coupling, i.e., any connection or coupling without additional intervening elements, may also be implemented by an indirect connection or coupling, i.e., a connection or coupling with one or more additional intervening elements, or vice versa, as long as the general purpose of the connection or coupling, for example, to transmit a certain kind of signal or to transmit a certain kind of information, is essentially maintained. Features from different embodiments may be combined to form further embodiments. For example, variations or modifications described with respect to one of the embodiments may also be applicable to other embodiments unless noted to the contrary.

The term “substantially” may be used herein to account for small manufacturing tolerances (e.g., within 5%) that are deemed acceptable in the industry without departing from the aspects of the embodiments described herein.

In an integrated circuit (IC) device reference voltage circuits are widely used to provide reference voltages that are relatively constant regardless of fluctuations in supply voltage, load, time, temperature, process variation, or the like. Accuracy and power consumption are important performance metrics for reference voltage circuits. Reference voltages may be used by many devices, such as comparators, voltage regulators, power supplies, analog-to-digital converters (ADCs), digital-to-analog converters (DACs), or other devices. In a reference voltage circuit mismatch between paired components can affect the accuracy of the reference voltage. As the size of the components in the reference voltage circuit decreases, mismatch effects due to short channel or channel length modulation become more significant.

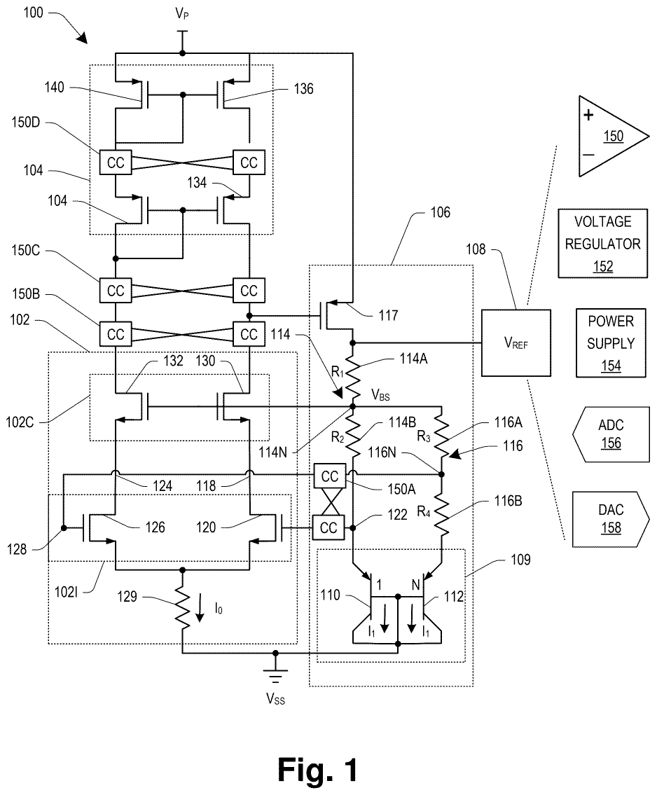

FIG. 1 is a diagram of a reference voltage circuit 100, according to some embodiments. In some embodiments, the reference voltage circuit 100 comprises a differential amplifier 102 comprising an input stage 1021 and a cascode stage 102C, a current mirror 104 connected to the differential amplifier 102, and an output stage 106 connected to the differential amplifier 102 and the current mirror 104 to generate a reference voltage (V_{REF}) at an output terminal 108.

In some embodiments, the output stage 106 comprises a current generator 109 including bipolar junction transistors 110, 112, where a magnitude of the reference voltage (V_{REF}) depends on a bandgap ratio of the bipolar junction transistors 110, 112. The bases and collectors of the bipolar junction transistors 110, 112 are connected to V_{SS} (e.g., ground). The bandgap ratio is based on the ratio of the sizes of the bipolar junction transistors 110, 112 (1:N). The output stage 106 comprises voltage dividers 114, 116 connected to the bipolar junction transistors 110, 112, respectively. In some embodiments, the voltage divider 114 comprises resistors 114A, 114B connected at a center node 114N, and the voltage divider 116 comprises resistors 116A, 116B connected at a center node 116N. An output transistor 117 is connected between a supply terminal (V_{S}) and the voltage divider 114 at the output terminal 108.

In some embodiments, the input stage 1021 comprises a first leg 118 having an input transistor 120 having a gate connected to a first input terminal 122 and a second leg 124 having an input transistor 126 having a gate connected to a second input terminal 128. The first input terminal 122 is connected to the bipolar junction transistor 110, and the second input terminal 128 is connected to the bipolar junction transistor 112 through the center node 116N of the voltage divider 116. A bias resistor 129 is connected to the sources of the input transistors 120, 126 for biasing the differential amplifier 102.

In some embodiments, the cascode stage 102C comprises a cascode transistor 130 in the first leg 118 and a cascode transistor 132 in the second leg 124. The gates of the cascode transistors 130, 132 are connected the center node 114N of the voltage divider 114. The voltage divider 114 generates a bootstrap voltage (V_{BS}) at the center node 114N for biasing the cascode transistors 130, 132. In some embodiments, the input transistors 120, 126 and the cascode transistors 130, 132 are n-type transistors.

In some embodiments, the current mirror 104 comprises cascoded mirror transistors 134, 136 connected between the supply terminal (V_{S}) and the first leg 118 and cascoded mirror transistors 138, 140 connected between the supply terminal (V_{S}) and the second leg 124. The cascoded mirror transistors 138, 140 are diode connected, where the gates of the cascoded mirror transistors 138, 140 are connected to the sources of the cascoded mirror transistors 138, 140. In some embodiments, the mirror transistors 134, 136, 138, 140 are p-type transistors.

In the reference voltage circuit 100, active components, such as current sources, are not required for generating bias currents, thereby reducing power consumption. The bootstrap voltage (V_{BS}) generated at the center node 114N of the voltage divider 114 biases the cascode stage 102C of the differential amplifier 102. The bias current (I₀) of the input transistors 120, 126 is defined by:

$${I}_{0} = \frac{Vbe - {Vgs}_{M 2}}{{R}_{0}} ,$$

where V_{be} is the base-to-emitter voltage of the bipolar junction transistor 110, Vas is the gate-to-source voltage of the input transistor 120, and R0 is the resistance of the bias resistor 129.

In some embodiments, the cascode transistors 130, 132 maintain the drain-to-source voltages of the input transistors 120,126 constant and the mirror transistors 134, 139 provide cascading to the mirror transistors 136, 140 to minimize current mismatch. The bootstrap voltage (V_{BS}) biases the cascode transistors 130, 132 according to:

$${V}_{BS} = {V}_{REF} - \frac{2 {R}_{1}}{{R}_{4}} \times \frac{kT \times ln ( N )}{q} ,$$

where R₁ is the resistance of the resistor 114A in the voltage divider 114, R₄ is the resistance of the resistor 116B in the voltage divider 116, k is the Boltzmann constant, T is the temperature, N is the bandgap ratio of the bipolar junction transistors 110, 112, and q is the electron electrical charge constant.

In some embodiments, current mode chopping circuits 150A, 150B, 150C, 150D are connected to switch the orientation of the legs 118, 124 periodically to reduce the impact of mismatch in the components of the legs 118, 124. In some embodiments, a switching frequency of the current mode chopping circuits 150A, 150B, 150C, 150D is about 1000 Hz.

In some embodiments, for sub-threshold operation, the bias current (I₀) is about 3 nA. The reference current (I₁) flowing through each of the bipolar junction transistors 110, 112 is about 3 nA, resulting in a total reference current in the reference voltage circuit 100 of about 9 nA. In some embodiments, the accuracy of the reference voltage circuit 100 is about 1% in active mode and about 2.75% in deep sleep mode.

In some embodiments, various devices may employ the reference voltage (V_{REF}). Example devices include a comparator 150, a voltage regulator 152, a power supply 154, an ADC 156, a DAC 158, or some other device.

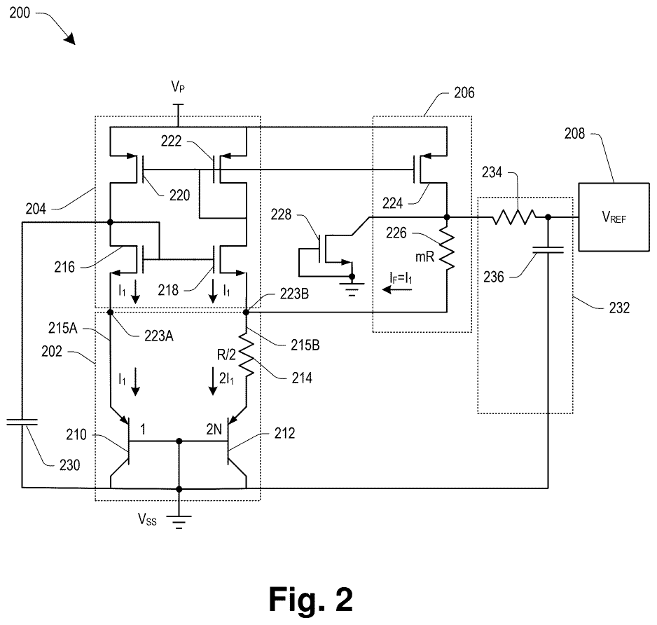

FIG. 2 is a diagram of a reference voltage circuit 200 with current feedback, according to some embodiments. In some embodiments, the reference voltage circuit 200 comprises a current generator 202, a common gate amplifier 204 connected to the current generator 202, and an output stage 206 connected to the common gate amplifier 204 to generate a reference voltage (V_{REF}) at an output terminal 208. In some embodiments, the output stage 206 generates feedback current for the current generator 202.

In some embodiments, the current generator 202 comprises bipolar junction transistors 210, 212 and a resistor 214 connected to the bipolar transistor 212, where a magnitude of the reference voltage (V_{REF}) depends on a bandgap ratio of the bipolar junction transistors 210, 212. The bases and collectors of the bipolar junction transistors 210, 212 are connected to V_{SS} (e.g., ground). The bandgap ratio is based on the ratio of the sizes of the bipolar junction transistors 210, 212 (1:2 N).

In some embodiments, the common gate amplifier 204 is connected to legs 215A, 215B of the current generator 202 and comprises current mirror transistors 216, 218 and current mirror transistors 220, 222 that generate a circulating current that forces the reference currents (I₁) and voltages at the inputs 223A, 223B of the current generator 202 to match. The reference current (I₁) flows through the leg 215A and a reference current (2I₁) equal to the sum of the reference current (I₁) from the common gate amplifier 204 and a feedback current (I_{F}=I₁) from the output stage 206 flows through the leg 215B. In some embodiments, the current mirror transistors 216, 218 are n-type transistors, and the current mirror transistors 220, 222 are p-type transistors. The current mirror transistors 216, 222 are diode connected.

In some embodiments, the output stage 206 comprises a current mirror transistor 224 that mirrors the reference current (I₁) in the common gate amplifier 204 to generate the feedback current (I_{F}) and a scaling resistor 226 having a resistance, mR, that increases the voltage at the output terminal 208 to generate the reference voltage, V_{REF}. The sum of the reference current (I₁) in the common gate amplifier 204 and the feedback current (I_{F}) generated by the current mirror transistor 224 equals the reference current (2I₁) in the second leg 215B of the current generator 202. In some embodiments, the size of the bipolar transistor 212 is doubled and the size of the resistor 214 is divided by two due to the current feedback from the output stage 206 as compared to a current generator without current feedback.

In some embodiments, a leakage compensation transistor 228 is connected to the current mirror transistor 224 to compensate for leakage in the current mirror transistors 216, 218. In some embodiments, the leakage compensation transistor 228 in an n-type transistor having a gate terminal connected to ground.

In some embodiments, power supply rejection ratio (PSSR) of the reference voltage circuit 200 is improved by adding one or more filters 230, 232. The filter 230 may comprise a capacitor connected to the common gate amplifier 204 between the current mirror transistors 216, 220. The filter 232 may be a low pass filter defined by a resistor 234 connected in series with a capacitor 236 and connected to the output terminal 208.

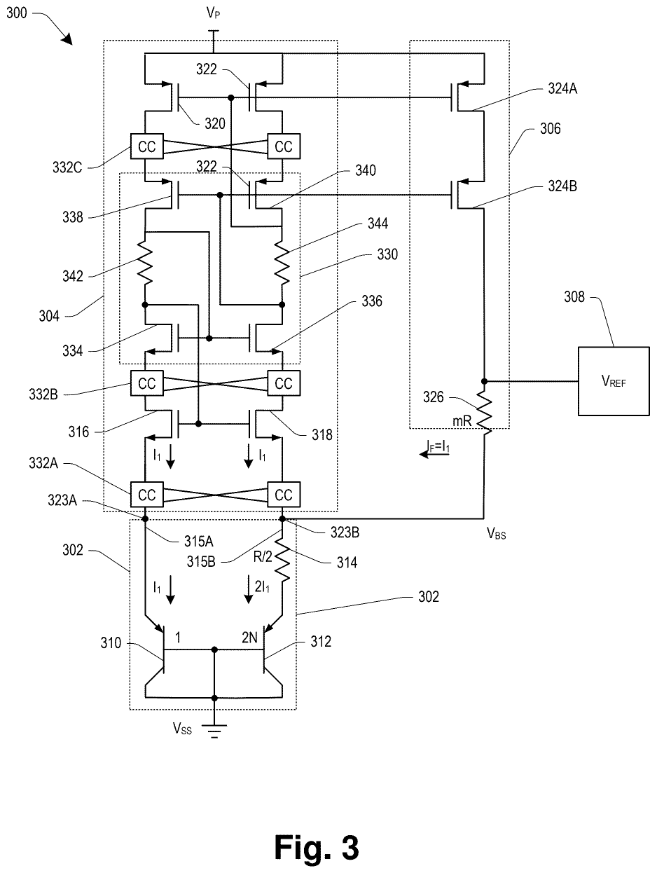

FIG. 3 is a diagram of a reference voltage circuit 300 with current feedback and current chopping, according to some embodiments. In some embodiments, the reference voltage circuit 300 comprises a current generator 302, a common gate amplifier 304 connected to the current generator 302, and an output stage 306 connected to the common gate amplifier 304 to generate a reference voltage (V_{REF}) at an output terminal 308. In some embodiments, the output stage 306 generates feedback current for the current generator 302.

In some embodiments, the current generator 302 comprises bipolar junction transistors 310, 312 and a resistor 314 connected to the bipolar transistor 312, where a magnitude of the reference voltage (V_{REF}) depends on a bandgap ratio of the bipolar junction transistors 310, 312. The bases and collectors of the bipolar junction transistors 310, 312 are connected to V_{SS} (e.g., ground). The bandgap ratio is based on the ratio of the sizes of the bipolar junction transistors 310, 312 (1:2 N).

In some embodiments, the common gate amplifier 304 is connected to legs 315A, 315B of the current generator 302 and comprises current mirror transistors 316, 318 having connected gates and current mirror transistors 320, 322 having connected gates that generate a circulating current that forces the reference currents (I₁) and voltages at the inputs 323A, 323B of the current generator 302 to match. The reference current (I₁) flows through the leg 315A and a reference current (2I₁) equal to the sum of the reference current (I₁) from the common gate amplifier 304 and feedback current (I_{F}=I₁) from the output stage 306 flows through the leg 315B. In some embodiments, the current mirror transistors 316, 318 are n-type transistors, and the current mirror transistors 320, 322 are p-type transistors.

In some embodiments, the output stage 306 comprises current mirror transistors 324A, 324B that mirror the reference current (I₁) in the common gate amplifier 304 to generate the feedback current, I_{F}, and a scaling resistor 326 having a resistance, mR, that increases the voltage at the output terminal 308 to generate the reference voltage, V_{REF}. The sum of the reference current (I₁) in the common gate amplifier 304 and the feedback current (I_{F}) generated by the current mirror transistor 324 equals the reference current (2I₁) in the second leg 315B of the current generator 302. In some embodiments, the size of the bipolar transistor 312 is doubled and the size of the resistor 314 is divided by two due to the current feedback from the output stage 306 as compared to a current generator without current feedback.

In some embodiments, the common gate amplifier 304 comprises a balancing circuit 330 to facilitate current mode chopping using chopping circuits 332A, 332B, 332C. The balancing circuit 330 forces the current and voltage at the chopping circuit 332B and the current and voltage at the chopping circuit 332C to match. In some embodiments, the balancing circuit 330 comprises balancing transistors 334, 336 having connected gates and balancing transistors 338, 340 having connected gates. Resistors 342, 344 are connected between the balancing transistors 334, 338 and the balancing transistors 336, 340, respectively. The gates of the current mirror transistors 316, 318 and the balancing transistors 334, 336 are connected to opposite sides the resistor 342. The gates of the current mirror transistors 320, 322 and the balancing transistors 338, 340 are connected to opposite sides the resistor 344. In some embodiments, the balancing transistors 334, 336 are n-type transistors, and the balancing transistors 338, 340 are p-type transistors. Because of the common-gate structure the balancing circuit 330 forces the currents in the resistors 342, 344 to match. Since the resistor currents are matched the source voltages of the balancing transistors 338, 340 and also the source voltages of the balancing transistors 338, 340 are forced to match. The chopping circuits 332A, 332B, 332C periodically alternate the current paths feeding the legs 315A, 315B of the current generator 302, thereby averaging out mismatches between components in the common gate amplifier 304, thereby increasing accuracy during active mode,

In some embodiments, the leakage compensation transistor 228, the filter 230, or the filter 232 illustrated in FIG. 2 may also be provided in the reference voltage circuit 300.

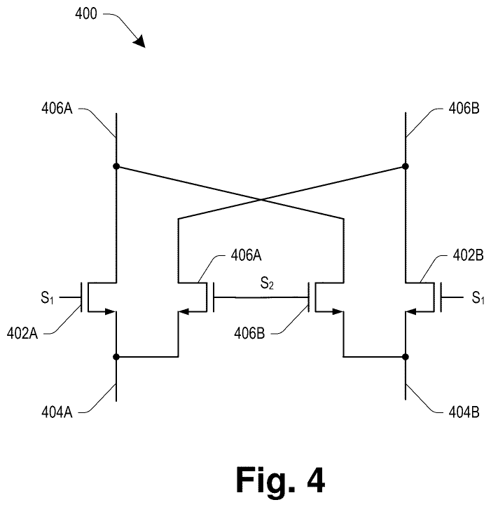

FIG. 4 is a diagram of a chopping circuit 400, in accordance with some embodiments. One or more of the chopping circuits 150A, 150B, 150C, 150D, 332A, 332B, 332C may be implemented by the chopping circuit 400. The chopping circuit 400 comprises a routing transistor 402A connected between “A” legs 404A, 406A and a routing transistor 402B connected between “B” legs 404B, 406B. A cross-routing transistor 406A is connected between the leg 404A and the leg 406B and a cross-routing transistor 406B is connected between the leg 404B and the leg 406A. The routing transistors 402A, 402B are controlled by a first switching signal (S1) and the cross-routing transistors 406A, 406B are controlled by a second switching signal (S2) in active mode. When the first switching signal (S1) is active, the routing transistors 402A, 402B connect the “A” legs 404A, 406A and the “B” legs 404B, 406B, respectively. When the second switching signal (S2) is active, the cross-routing transistor 406A cross-couples the “A” leg 404A to the “B” leg 406B and the cross-routing transistor 406B cross-couples the “B” leg 404B to the “A” leg 406A. Periodically cross-coupling the “A” leg and the “B” leg alternates the current paths to average out mismatches in components connected to the legs 404A, 404B, 406A, 406B, thereby increasing accuracy of the reference voltage, V_{REF}. During deep sleep mode, the routing transistors 402A, 402B connect the “A” legs 404A, 406A and the “B” legs 404B, 406B, respectively, without switching.

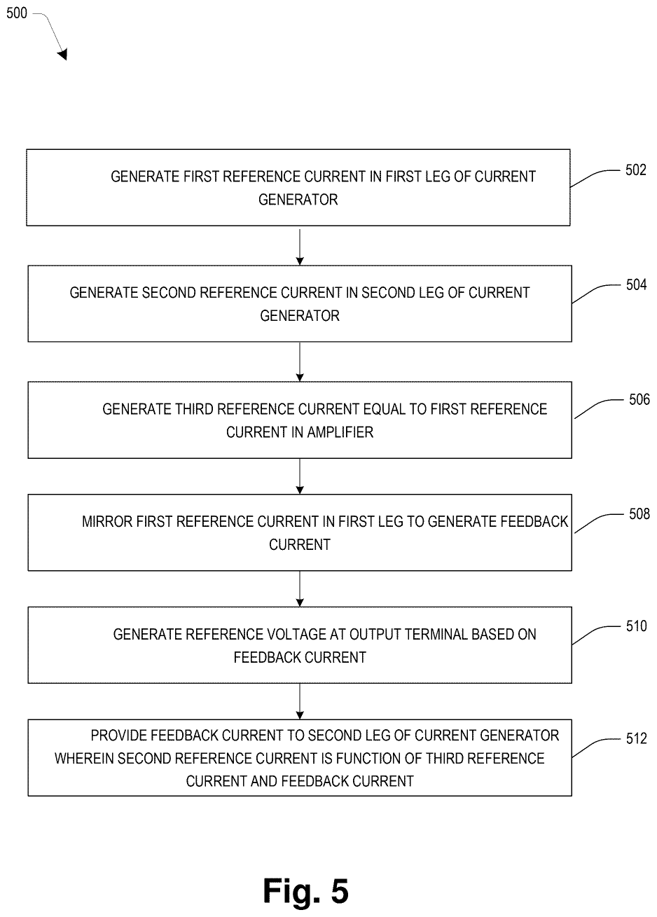

FIG. 5 is a flow diagram of a method 500 for generating a reference voltage, according to some embodiments. At 502, a first reference current is generated in a first leg 215A, 315A of a current generator 202, 302. At 504, a second reference current is generated in a second leg 215B, 315B of the current generator 202, 302. At 506, a third reference current equal to the first reference current is generated in an amplifier 204, 304. At 508, the first reference current in the first leg 215A, 215B is mirrored to generate a feedback current. At 510, a reference voltage is generated at an output terminal 208, 308 based on the feedback current. At 512, the feedback current is provided to the second leg 215B, 315B of the current generator 202, 302 such that the second reference current comprises a sum of the third reference current and the feedback current.

According to one or more embodiments, a reference voltage circuit comprises a current generator comprising a first leg configured to generate a first reference current, and a second leg configured to generate a second reference current, an amplifier connected between a supply terminal and the current generator and configured to generate a third reference current, and an output stage configured to mirror the first reference current in the first leg to generate a feedback current, generate a reference voltage at an output terminal based on the feedback current, and provide the feedback current to the second leg of the current generator, wherein the second reference current is a function of the third reference current and the feedback current.

According to one or more embodiments, the first leg of the current generator comprises a first bipolar junction transistor having a first size, and the second leg of the current generator comprises a resistor, and a second bipolar junction transistor connected to the resistor and having a second size greater than the first size, wherein the output stage is connected to the resistor.

According to one or more embodiments, a base of the first bipolar junction transistor is connected to a base of the second bipolar junction transistor, an emitter of the first bipolar junction transistor is connected to the amplifier, an emitter of the second bipolar junction transistor is connected to the amplifier, and a collector of the first bipolar junction transistor is connected to a collector of the second bipolar junction transistor.

According to one or more embodiments, the amplifier comprises a first transistor connected to the first leg and having a first gate and a first source connected to the first gate, a second transistor connected between the supply terminal and the first transistor and having a second gate, a third transistor connected to the second leg and having a third gate connected to the first gate, and a fourth transistor connected between the supply terminal and the third transistor and having a fourth gate connected to the second gate and a second source connected to the fourth gate.

According to one or more embodiments, the output stage comprises a mirror transistor connected to the supply terminal and the output terminal and having a fifth gate connected to the second gate and the fourth gate, and a resistor connected between the mirror transistor and the second leg.

According to one or more embodiments, the reference voltage circuit comprises a filter connected to a node between the first transistor and the second transistor.

According to one or more embodiments, the reference voltage circuit comprises a low pass filter connected to the output terminal.

According to one or more embodiments, the reference voltage circuit comprises a leakage compensation transistor connected to the output terminal.

According to one or more embodiments, the amplifier comprises a first current chopping circuit connected to the first leg and the second leg of the current generator, a first transistor connected to the first current chopping circuit and having a first gate, a second transistor connected to the first current chopping circuit and having a second gate connected to the first gate, a second current chopping circuit connected to the first transistor and the second transistor, a balancing circuit connected to the first transistor and the second transistor, a third current chopping circuit connected to the balancing circuit, a third transistor connected to the supply terminal and the balancing circuit and having a third gate, and a fourth transistor connected to the supply terminal and the balancing circuit and having a fourth gate connected to the third gate, wherein the balancing circuit is configured to match voltage and current at the second current chopping circuit and to match voltage and current at the third current chopping circuit.

According to one or more embodiments, a reference voltage circuit comprises an output terminal, and a current generator comprising a first bipolar junction transistor having a first size, a resistor, a second bipolar junction transistor connected to the resistor and having a second size greater than the first size, an output stage configured to mirror current in the first bipolar junction transistor to generate a feedback current and generate a reference voltage at the output terminal, and an amplifier connected to the first bipolar junction transistor and the resistor and configured to balance current in the first bipolar junction transistor and the second bipolar junction transistor such that current in the second bipolar junction transistor includes the current in the first bipolar junction transistor and the feedback current.

According to one or more embodiments, a base of the first bipolar junction transistor is connected to a base of the second bipolar junction transistor, an emitter of the first bipolar junction transistor is connected to the amplifier, an emitter of the second bipolar junction transistor is connected to the amplifier, and a collector of the first bipolar junction transistor is connected to a collector of the second bipolar junction transistor.

According to one or more embodiments, the amplifier comprises a first transistor connected to the first bipolar junction transistor and having a first gate and a first source connected to the first gate, a second transistor connected between a supply terminal and the first transistor and having a second gate, a third transistor connected to the resistor and having a third gate connected to the first gate, and a fourth transistor connected between the supply terminal and the third transistor and having a fourth gate connected to the second gate and a second source connected to the fourth gate.

According to one or more embodiments, the output stage comprises a mirror transistor connected to the supply terminal and the output terminal and having a fifth gate connected to the second gate and the fourth gate, and a second resistor connected between the mirror transistor and the resistor.

According to one or more embodiments, the reference voltage circuit comprises a filter connected to a node between the first transistor and the second transistor.

According to one or more embodiments, the reference voltage circuit comprises a low pass filter connected to the output terminal.

According to one or more embodiments, the reference voltage circuit comprises a leakage compensation transistor connected to the output terminal.

According to one or more embodiments, the amplifier comprises a first current chopping circuit connected to the first bipolar junction transistor and the resistor, a first transistor connected to the first current chopping circuit and having a first gate, a second transistor connected to the first current chopping circuit and having a second gate connected to the first gate, a second current chopping circuit connected to the first transistor and the second transistor, a balancing circuit connected to the first transistor and the second transistor, a third current chopping circuit connected to the balancing circuit, a third transistor connected to a supply terminal and the balancing circuit and having a third gate, and a fourth transistor connected to the supply terminal and the balancing circuit and having a fourth gate connected to the third gate, wherein the balancing circuit is configured to match voltage and current at the second current chopping circuit and to match voltage and current at the third current chopping circuit.

According to one or more embodiments, a method for generating a reference voltage comprises generating a first reference current in a first leg of a current generator, generating a second reference current in a second leg of the current generator, generating a third reference current equal to the first reference current in an amplifier, mirroring the first reference current in the first leg to generate a feedback current, generating a reference voltage at an output terminal based on the feedback current, and providing the feedback current to the second leg of the current generator, wherein the second reference current is a function of the third reference current and the feedback current.

According to one or more embodiments, the method comprises connecting a filter to at least one of the amplifier or the output terminal.

According to one or more embodiments, the method comprises connecting a leakage compensation transistor modeling leakage current in the amplifier to the output terminal.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Moreover, “exemplary” and/or the like is used herein to mean serving as an example, instance, illustration, etc., and not necessarily as advantageous. Rather, use of the word “example” and/or the like is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, “or” is intended to mean an inclusive “or” rather than an exclusive “or”. In addition, “a” and “an” as used in this application and the appended claims are generally to be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A reference voltage circuit, comprising:
a current generator comprising:
a first leg configured to generate a first reference current; and
a second leg configured to generate a second reference current;
an amplifier connected between a supply terminal and the current generator and configured to generate a third reference current; and
an output stage configured to:
mirror the first reference current in the first leg to generate a feedback current;
generate a reference voltage at an output terminal based on the feedback current; and
provide the feedback current to the second leg of the current generator, wherein the second reference current is a function of the third reference current and the feedback current.

2. The reference voltage circuit of claim 1, wherein:
the first leg of the current generator comprises a first bipolar junction transistor having a first size; and
the second leg of the current generator comprises:
a resistor; and
a second bipolar junction transistor connected to the resistor and having a second size greater than the first size, wherein:
the output stage is connected to the resistor.

3. The reference voltage circuit of claim 2, wherein:
a base of the first bipolar junction transistor is connected to a base of the second bipolar junction transistor;
an emitter of the first bipolar junction transistor is connected to the amplifier;
an emitter of the second bipolar junction transistor is connected to the amplifier; and
a collector of the first bipolar junction transistor is connected to a collector of the second bipolar junction transistor.

4. The reference voltage circuit of claim 1, wherein:
the amplifier comprises:
a first transistor connected to the first leg and having a first gate and a first source connected to the first gate;
a second transistor connected between the supply terminal and the first transistor and having a second gate;
a third transistor connected to the second leg and having a third gate connected to the first gate; and
a fourth transistor connected between the supply terminal and the third transistor and having a fourth gate connected to the second gate and a second source connected to the fourth gate.

5. The reference voltage circuit of claim 4, wherein:
the output stage comprises:
a mirror transistor connected to the supply terminal and the output terminal and having a fifth gate connected to the second gate and the fourth gate; and
a resistor connected between the mirror transistor and the second leg.

6. The reference voltage circuit of claim 4, comprising:
a filter connected to a node between the first transistor and the second transistor.

7. The reference voltage circuit of claim 1, comprising:
a low pass filter connected to the output terminal.

8. The reference voltage circuit of claim 1, comprising:
a leakage compensation transistor connected to the output terminal.

9. The reference voltage circuit of claim 1, wherein:
the amplifier comprises:
a first current chopping circuit connected to the first leg and the second leg of the current generator;
a first transistor connected to the first current chopping circuit and having a first gate;
a second transistor connected to the first current chopping circuit and having a second gate connected to the first gate;
a second current chopping circuit connected to the first transistor and the second transistor;
a balancing circuit connected to the first transistor and the second transistor;
a third current chopping circuit connected to the balancing circuit;
a third transistor connected to the supply terminal and the balancing circuit and having a third gate; and
a fourth transistor connected to the supply terminal and the balancing circuit and having a fourth gate connected to the third gate, wherein:
the balancing circuit is configured to match voltage and current at the second current chopping circuit and to match voltage and current at the third current chopping circuit.

10. A reference voltage circuit, comprising:
an output terminal; and
a current generator comprising:
a first bipolar junction transistor having a first size;
a resistor;
a second bipolar junction transistor connected to the resistor and having a second size greater than the first size;
an output stage configured to mirror current in the first bipolar junction transistor to generate a feedback current and generate a reference voltage at the output terminal; and
an amplifier connected to the first bipolar junction transistor and the resistor and configured to balance current in the first bipolar junction transistor and the second bipolar junction transistor such that current in the second bipolar junction transistor includes the current in the first bipolar junction transistor and the feedback current.

11. The reference voltage circuit of claim 10, wherein:
a base of the first bipolar junction transistor is connected to a base of the second bipolar junction transistor;
an emitter of the first bipolar junction transistor is connected to the amplifier;
an emitter of the second bipolar junction transistor is connected to the amplifier; and
a collector of the first bipolar junction transistor is connected to a collector of the second bipolar junction transistor.

12. The reference voltage circuit of claim 10, wherein:
the amplifier comprises:
a first transistor connected to the first bipolar junction transistor and having a first gate and a first source connected to the first gate;
a second transistor connected between a supply terminal and the first transistor and having a second gate;
a third transistor connected to the resistor and having a third gate connected to the first gate; and
a fourth transistor connected between the supply terminal and the third transistor and having a fourth gate connected to the second gate and a second source connected to the fourth gate.

13. The reference voltage circuit of claim 12, wherein:
the output stage comprises:
a mirror transistor connected to the supply terminal and the output terminal and having a fifth gate connected to the second gate and the fourth gate; and
a second resistor connected between the mirror transistor and the resistor.

14. The reference voltage circuit of claim 12, comprising:
a filter connected to a node between the first transistor and the second transistor.

15. The reference voltage circuit of claim 10, comprising:
a low pass filter connected to the output terminal.

16. The reference voltage circuit of claim 10, comprising:
a leakage compensation transistor connected to the output terminal.

17. The reference voltage circuit of claim 10, wherein:
the amplifier comprises:
a first current chopping circuit connected to the first bipolar junction transistor and the resistor;
a first transistor connected to the first current chopping circuit and having a first gate;
a second transistor connected to the first current chopping circuit and having a second gate connected to the first gate;
a second current chopping circuit connected to the first transistor and the second transistor;
a balancing circuit connected to the first transistor and the second transistor;
a third current chopping circuit connected to the balancing circuit;
a third transistor connected to a supply terminal and the balancing circuit and having a third gate; and
a fourth transistor connected to the supply terminal and the balancing circuit and having a fourth gate connected to the third gate, wherein:
the balancing circuit is configured to match voltage and current at the second current chopping circuit and to match voltage and current at the third current chopping circuit.

18. A method for generating a reference voltage, comprising:
generating a first reference current in a first leg of a current generator;
generating a second reference current in a second leg of the current generator;
generating a third reference current equal to the first reference current in an amplifier;
mirroring the first reference current in the first leg to generate a feedback current;
generating a reference voltage at an output terminal based on the feedback current; and
providing the feedback current to the second leg of the current generator, wherein the second reference current is a function of the third reference current and the feedback current.

19. The method of claim 18, comprising:
connecting a filter to at least one of the amplifier or the output terminal.

20. The method of claim 18, comprising:
connecting a leakage compensation transistor modeling leakage current in the amplifier to the output terminal.
